(19) United States
(12) Patent Application Publication
(10) Pub. No.: US 2010/0113252 A1
(43) Pub. Date: May 6, 2010

(54) CROSSLINKED SILICONE COMPOUNDS AND METHODS FOR CROSSLINKING SILICONE COMPOUNDS BY IN SITU WATER GENERATION

(75) Inventors: Rajendra K. Bordia, Seattle, WA (US); Michael Scheffler, Erlangen (DE)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: WASHINGTON, UNIVERSITY OF, Seattle, WA (US)

(21) Appl. No.: 11/539,457

(22) Filed: Oct. 6, 2006

Related U.S. Application Data
(63) Continuation of application No. PCT/US05/12857, filed on Apr. 15, 2005.
(60) Provisional application No. 60/562,745, filed on Apr. 16, 2004.

(51) Int. Cl. C08L 83/04; C08G 77/38; B05D 3/10; B05D 5/00; C04B 35/00

(52) U.S. Cl. 501/154; 525/474; 427/387; 427/256; 524/588

(57) ABSTRACT

Methods for crosslinking polysiloxane compounds, crosslinked polysiloxane compounds, methods for making ceramic products from the crosslinked polysiloxane compounds, and ceramic products made from the crosslinked polysiloxane compounds.

### CROSS-REFERENCES TO RELATED APPLICATIONS

This application is a continuation of International Patent Application No. PCT/US2005/012857, filed Apr. 15, 2005, which claims the benefit of U.S. Provisional Application No. 60/652,745, filed Apr. 16, 2004. Each application is incorporated herein by reference in its entirety.

### STATEMENT OF GOVERNMENT LICENSE RIGHTS

This invention was made with government support under Contract No. DE-AC06-76RL01830, PNNL TO4125, awarded by the Department of Energy. The government has certain rights in the invention.

### BACKGROUND OF THE INVENTION

Deposition of small amounts of functional materials has become a matter of intensive research during the last years. A promising and widely used technique for the fabrication of small parts with specific optical, electrical, chemical, biological or structural functionalities into well-defined locations is the inkjet printing technology. After optimization of the basic requirements, mainly the viscosity and surface tension of the ink system, a wide field of materials systems can be processed. Examples include specific polymers into thin-film transistor circuits and light-emitting polymer displays, biomolecules into biochips, three-dimensional scaffolds as templates for biomedical applications, conductive gold tracks on substrates or cobalt nanoparticles for catalytic growth of carbon nanotubes, or for combinatorial materials research. Ceramic particle-loaded inks have been developed containing ZrO₂ or ZrO₂/Al₂O₃ and PZT-powders. The filler amount in the dispersant liquid which is used as a transportation vehicle for the inkjet printing process, however, is limited. Details of the inkjet printing process with respect to the flow process and the operating parameters of the printhead have been modelled, and alumina suspensions with a volume fraction of up to 0.4 have been used for ceramic green part manufacturing. An alternative route to increase the solid content is the use of a slurry consisting of a preceramic polymer and a ceramic powder dispersed in a solvent.

Processing of preceramic polymers into ceramic products involves shaping of a low viscous polymer precursor, subsequent curing and pyrolysis at temperatures above 800° C. Due to the pronounced density differences between the polymer (1-1.2 g/cm³) and the ceramic phases (2-3 g/cm³) shrinkage of up to 70 volume percent may occur which gives rise to extensive porosity or cracking in the pyrolyzed ceramic residue. Manufacturing of ceramic parts from preceramic polymers, however, is facilitated when the polymer is loaded with a filler powder. Inert filler powders such as Al₂O₃, SiC, B₄C, and Si₃N₄, as well as reactive fillers such as Ti, Cr, Mo, B, and MoSi₂, which may react with the solid and gaseous decomposition products of the polymer precursor to form carbides and oxides, have been successfully used to reduce the polymer-to-ceramic shrinkage and to improve the mechanical properties of non-oxide as well as oxide based polymer derived ceramics.

Despite the advances in the development of preceramic polymers and their increased capacities, there exists a need for improved preceramic materials, methods for making these materials, and methods for making ceramic products using these materials. The present invention seeks to fulfil this need and provides further related advantages.

### SUMMARY OF THE INVENTION

In one aspect, the invention provides a method for crosslinking a polysiloxane silicone compound. In the method, a crosslinking catalyst is added to a mixture of a hydroxy-terminated polysiloxane and a crosslinkable polysiloxane having a hydrolyzable functional group, wherein the crosslinking catalyst causes the condensation of the hydroxy-terminated polysiloxane and the generation of water, and wherein the water generated by the condensation hydrolyzes the hydrolyzable functional group resulting in the crosslinking of the crosslinkable polysiloxane.

In another aspect of the invention, crosslinked polysiloxane compounds are provided. The crosslinked polysiloxane is obtainable by adding a crosslinking catalyst to a mixture of a hydroxy-terminated polysiloxane and a crosslinkable polysiloxane having a hydrolyzable functional group, wherein the crosslinking catalyst causes the condensation of the hydroxy-terminated polysiloxane and the generation of water, and wherein the water generated by the condensation hydrolyzes the hydrolyzable functional group resulting in the crosslinking of the crosslinkable polysiloxane.

In a further aspect, the invention provides a method for making a ceramic product using the crosslinked polysiloxane compounds. The method includes the steps of:

(a) shaping a preceramic polymer mixture to provide a shaped preceramic polymer mixture, wherein the preceramic polymer mixture comprises a mixture of a hydroxy-terminated polysiloxane and a crosslinkable polysiloxane having a hydrolyzable functional group treated with a crosslinking catalyst, wherein the crosslinking catalyst causes the condensation of the hydroxy-terminated polysiloxane and the generation of water, and wherein the water generated by the condensation hydrolyzes the hydrolyzable functional group resulting in the crosslinking of the crosslinkable polysiloxane;

(b) curing the shaped preceramic polymer mixture to provide a cured, shaped preceramic polymer mixture; and

(c) pyrolyzing the cured, shaped preceramic polymer mixture to provide a ceramic product.

In another aspect of the invention, ceramic products made from the crosslinked silicone compounds are provided. The ceramic products are obtainable by the process of:

(a) shaping a preceramic polymer mixture to provide a shaped preceramic polymer mixture, wherein the preceramic polymer mixture comprises a mixture of a hydroxy-terminated polysiloxane and a crosslinkable polysiloxane having a hydrolyzable functional group treated with a crosslinking catalyst, wherein the crosslinking catalyst causes the condensation of the hydroxy-terminated polysiloxane and the generation of water, and wherein the water generated by the condensation hydrolyzes the hydrolyzable functional group resulting in the crosslinking of the crosslinkable polysiloxane;

(b) curing the shaped preceramic polymer mixture to provide a cured, shaped preceramic polymer mixture; and

(c) pyrolyzing the cured, shaped preceramic polymer mixture to provide a ceramic product.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic illustration of a polysiloxane crosslinking mechanism, FIG. 1A illustrates in situ water formation through hydroxy-terminated polysiloxane condensation, and FIG. 1B illustrates hydrolysis and crosslinking of a crosslinkable polysiloxane;

FIG. 2 illustrates the time-viscosity dependence of a representative polysiloxane mixture (MSE-100/DMS-S12) after catalyst addition (weight fraction M_{MSE-100}=0.7);

FIG. 3 is an infrared spectrum of the —OH region of a representative polysiloxane mixture (MSE-100/DMS-S12) after catalyst addition, as a function of time;

FIG. 4 is an infrared spectrum of the fingerprint region of a representative polysiloxane mixture (MSE-100/DMS-S12) after catalyst addition, as a function of time;

FIG. 5 illustrates the viscosity of a representative polysiloxane mixture (MSE-100/DMS-S12/hexane) as a function of the n-hexane volume fraction at 20° C.;

FIG. 6A illustrates the thermogravimetric curves for a representative polysiloxane mixture (MSE-100/DMS-S12) with different crosslinkable polysiloxane (MSE-100) weight fractions (0.70, 0.54, and 0.37), FIG. 6B illustrates the first derivatives of the curves in FIG. 6A;

FIG. 7 illustrates the weight loss for a representative polysiloxane mixture (MSE-100/DMS-S12) with different crosslinkable polysiloxane (MSE-100) weight fractions after drying at 110° C. and the total weight loss after drying and pyrolysis at 1000° C. in argon atmosphere;

FIG. 8 compares the ceramic yields of three representative polysiloxane systems (S-7, S-8, and S-10); and

FIGS. 9A-9C are images of the bubble jet printhead design useful in the inkjet printing method for making crosslinked polysiloxanes.

### DETAILED DESCRIPTION OF THE PREFERRED EMBODIMENT

The present invention relates to methods for crosslinking a silicone compound, crosslinked silicone compounds and their use as preceramic polymers, methods for making ceramic products from the crosslinked silicone compounds, and ceramic products made from crosslinked silicone compounds.

As used herein the terms “silicone compound” and “polysiloxane” have the same meaning and are used interchangeably. Polysiloxanes have the following general formula:

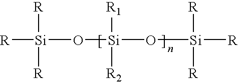

where R, R₁, and R₂ are independently selected from among a variety of groups including, for example, alkyl groups, aryl groups, alkoxy groups, hydroxy, halogens, and hydrogen, among others, and n is an integer indicating the number of repeating units in the polymer. Polydimethylsiloxane is a representative polysiloxane in which the R groups (R, R₁, and R₂) in the above formula are methyl groups (CH₃). For polydimethylsiloxane, the polysiloxane has a dimethylsiloxane (—Si(CH₃)₂O—) repeating unit (n units) and is terminated with a trimethylsiloxy group (CH₃)₃SiO—)). The properties of polysiloxanes are determined by their substituents (i.e., R, R₁, and R₂) and the number of repeating units (n). Common polysiloxanes include, in addition to polydimethylsiloxane, polydiethylsiloxane, polymethylphenylsiloxane (R₁ is methyl and R₂ is phenyl), polydiphenylsiloxane (R₁ and R₂ are phenyl). The viscosity of polysiloxanes can vary greatly and depends on the number of repeating units as well as the polysiloxane's substituents. Polysiloxane viscosity can range from about 1 to about 400,000 centistokes.

In one aspect the invention provides a method for crosslinking a silicone compound (i.e., a polysiloxane). In the method, a mixture of a hydroxy-terminated polysiloxane and a crosslinkable polysiloxane are treated with a crosslinking catalyst. The crosslinking catalyst catalyzes a condensation reaction between two hydroxy-terminated polysiloxanes resulting in an ether bond between the two polysiloxanes (e.g., A-SiR₂—O—SiR₂—B, where A is the remainder of the first polysiloxane and B is the remainder of the second polysiloxane) and the formation of water. The water formed in situ by the condensation reaction reacts with the crosslinkable polysiloxane, which has a hydrolyzable functional group (e.g., alkoxy). Reaction of water with the crosslinkable polysiloxane's hydrolyzable functional group results hydrolysis and the formation of a crosslink (i.e., an ether bond) between the first and second crosslinkable polysiloxanes (e.g., C₁—SiR—O—SiR—C₂, where C₁ and C₂ represent the remainder of the first and second crosslinkable polysiloxanes). Because the crosslinkable polysiloxane has multiple hydrolyzable groups and because the condensation reaction produces multiple equivalents of water, multiple crosslinks between the crosslinkable polysiloxanes are formed leading to a crosslinked polysiloxane network.

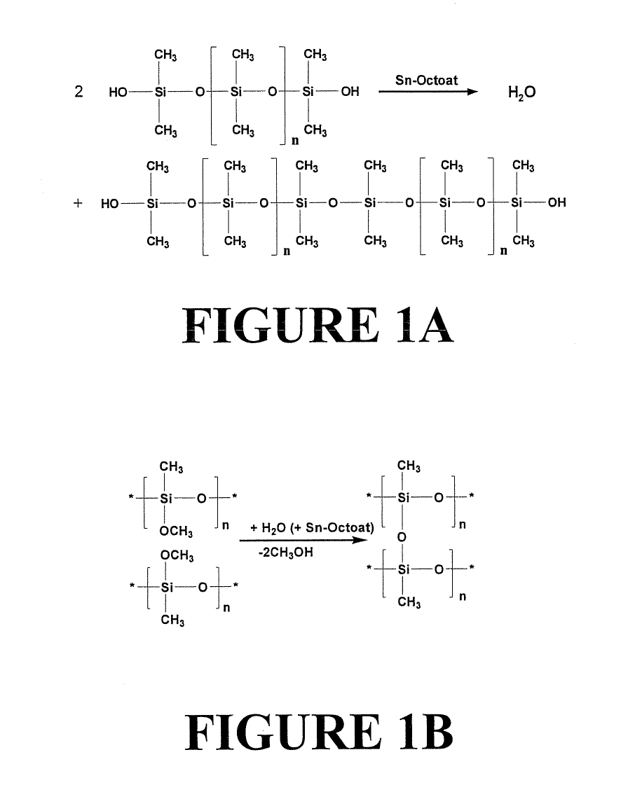

The first step in the crosslinking method, in situ water formation, is illustrated schematically in FIG. 1A. Referring to FIG. 1A, treatment of a representative hydroxy-terminated polysiloxane (i.e., polydimethylsiloxane, hydroxy terminated) with a representative crosslinking catalyst (e.g., bis(2-ethylhexanoate)tin, referred to as Sn-Octoat in FIG. 1) to provide a condensation product, a second hydroxy-terminated polydimethylsiloxane, and water. The second step in the crosslinking method, hydrolysis and crosslink formation, is illustrated schematically in FIG. 1B. Referring to FIG. 1B, water formed by the condensation reaction in the first step causes hydrolysis of a representative crosslinkable polysiloxane having a hydrolyzable functional group (i.e., polymethoxymethylsiloxane) and concomitant ether bond formation (i.e., crosslink) to provide the crosslinked polysiloxane.

Suitable hydroxy-terminated polysiloxanes useful in the invention include hydroxy-terminated polysiloxanes having viscosities in the range from about 1 to about 1000 mPas. Representative hydroxy-terminated polysiloxanes include hydroxy-terminated polydimethyl siloxanes commercially available from Gelest, Inc., Morrisville, Pa., under the designation DMS-S12 (16-32 cst), DMS-S14 (35-45 cst), DMS-S15 (45-48 cst), DMS-S21 (90-120 cst), and DMS-S27 (700-800 cst). For these hydroxy-terminated polydimethylsiloxanes, the viscosity of these products is noted as a range in centistokes (cst).

Water formed in situ by condensation of two hydroxy-terminated polysiloxanes reacts with a crosslinkable polysiloxane. As used herein, the term “crosslinkable polysiloxane” refers to a polysiloxane having a hydrolyzable functional group (i.e., reacts with water) to form a reactive functional group that is capable of further reaction with a suitably functionalized polysiloxane to form a covalent crosslink. Suitable hydrolyzable functional groups include, for example, alkoxy groups such as methoxy (i.e., Si—OMe) and ethoxy groups (i.e., Si—OEt), among others. Suitably functionalized polysiloxanes that are capable of reaction with the crosslinkable polysiloxane include, for example, hydroxy- substituted polysiloxanes (e.g., Si—OH). Representative covalent crosslinks formed by the reaction of a crosslinkable polysiloxane and a suitably functionalized polysiloxane include ether crosslinks (i.e., Si—O—Si).

Suitable crosslinkable polysiloxanes useful in the invention include polysiloxanes having hydrolyzable functional groups, the hydrolysis of which results in ether (i.e., —Si—O—Si—) bond formation between polysiloxanes (i.e., polysiloxane crosslinks). Suitably, the crosslinkable polysiloxanes have viscosities in the range from about 1 to about 1000 mPas. Representative crosslinkable polysiloxanes include poly(alkoxy)(alkyl)siloxanes (e.g., polysiloxanes having a —Si(OR)(R)—O— repeating unit, where R is an alkyl group, such as methyl). Representative crosslinkable polysiloxanes include polymethoxymethylsiloxane (commercially available from Wacker Silicon AG, Muenchen, Germany, under the designation MSE-100). Another crosslinkable compound useful in the invention is a highly alkylated, low molecular weight alkoxypolysiloxan (BAYSILONE Impragniermittel LO—N).

In one embodiment, the ratio of hydroxy-terminated polysiloxane to crosslinkable polysiloxane is about 40:60 percent by weight based on the total weight of the two polysiloxanes. In another embodiment, the ratio of hydroxy-terminated polysiloxane to crosslinkable polysiloxane is about 30:70 percent by weight based on the total weight of the two polysiloxanes. In a further embodiment, the ratio of hydroxy-terminated polysiloxane to crosslinkable polysiloxane is about 15:85 percent by weight based on the total weight of the two polysiloxanes.

Suitable crosslinking catalysts include compounds that catalyze the condensation of hydroxy-terminated polysiloxanes. In one embodiment, the crosslinking catalyst is bis(2-ethylhexanoate)tin (commercially available as a 50 weight percent polydimethylsiloxane composition from Gelest, Inc., Morrisville, Pa., under the designation SNB-1101).

In one embodiment, the amount of catalyst used is from about 0.5 to about 4.0 percent by weight (calculated as Sn cations contained in the catalyst composition) based on the total weight of polysiloxanes. For the catalyst solution noted above (i.e., SNB-1101), the amount of the catalyst solution is from about 3.4 to about 28 percent by weight based on the total weight of polysiloxanes.

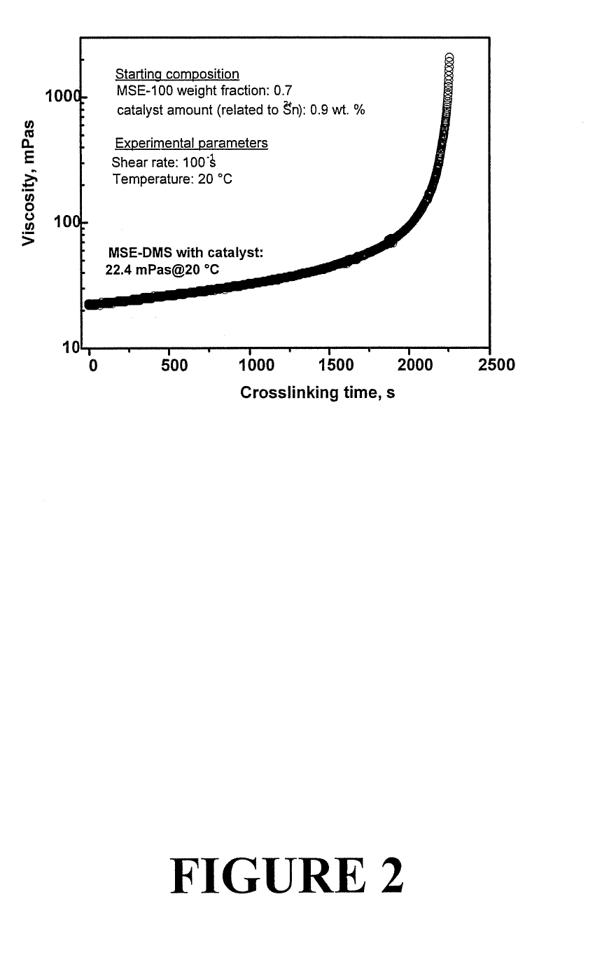

A crosslinked polysiloxane has a viscosity significantly greater than the polysiloxane(s) from which the crosslinked polysiloxane is derived. The viscosity of a representative mixture of a hydroxy-terminated polysiloxane and a crosslinkable polysiloxane (e.g., MSE-100/DMS-S12 mixture) after catalyst addition as a function of time is shown in FIG. 2. In this half-logarithmical scale, the viscosity increased linearly over a period of about 1700 seconds, and devolved into a step increase. When the temperature was increased prior to catalyst addition, the time of the linear viscosity increase could be reduced to about 200 seconds at 60° C.

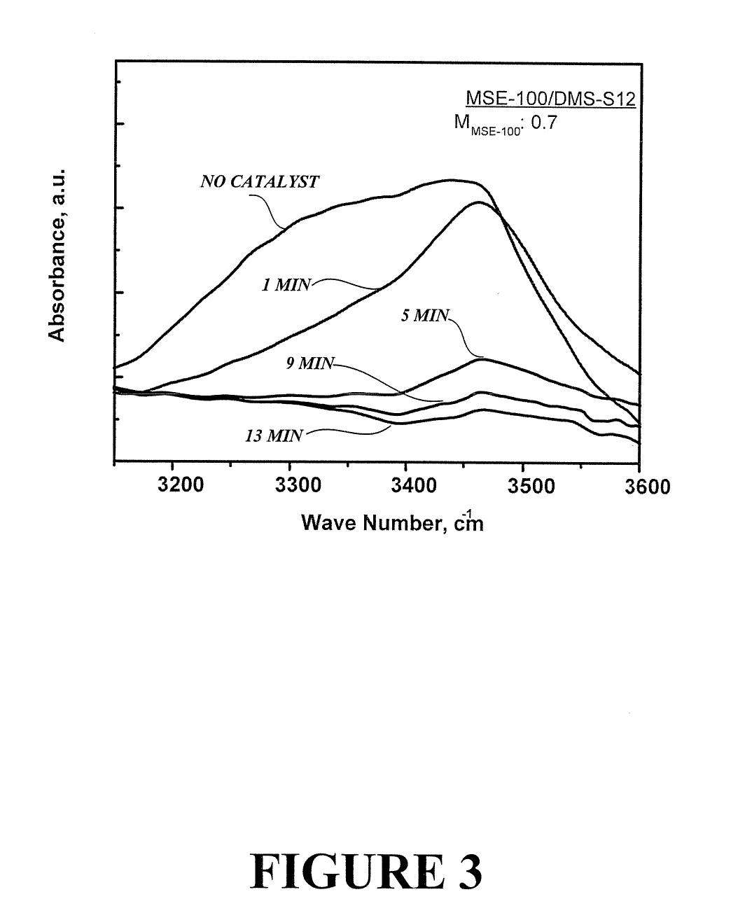

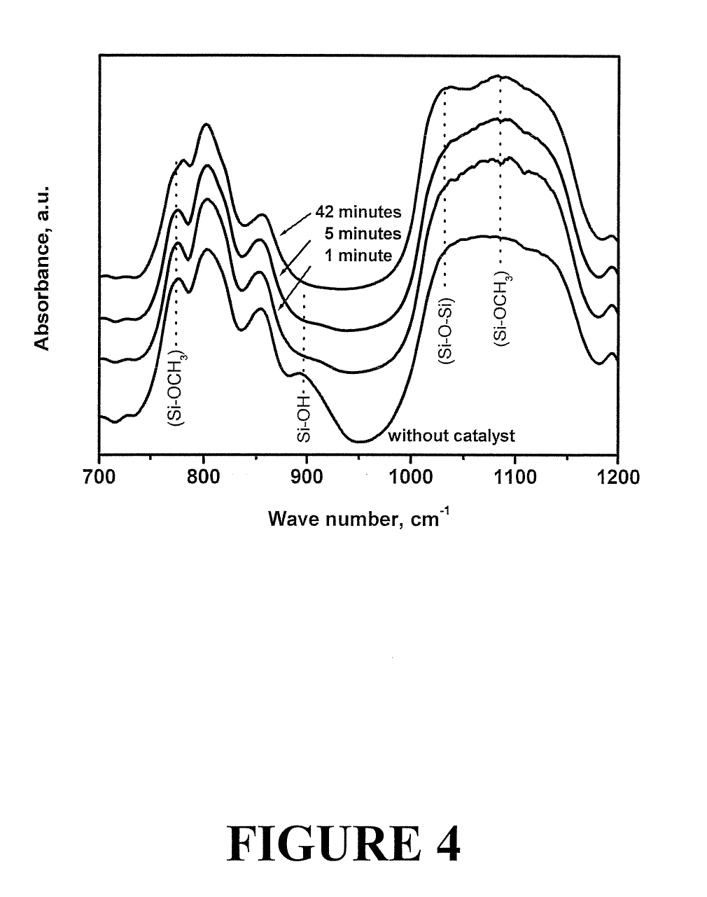

When the catalyst was added to the DMS-S12 only, within a few seconds a cloudy precipitation appeared, which originated from the condensation reaction of the hydroxyl groups of the dimethylpolysiloxane. This effect was not observed, when the catalyst was added to the MSE-100/DMS-S12 mixture, which remained clear and colorless even after the viscosity increase. Infrared spectra showed, that the first step of crosslinking is the formation of water from the DMS-S12. FIGS. 3 and 4 show the infrared spectra of the —OH region and fingerprint region, respectively, of a mixture of MSE-100 and DMS-S12, with and without catalyst, as a function of time.

Thus, in another aspect, the invention provides a crosslinked polysiloxane. The crosslinked polysiloxanes of the invention are obtainable by adding a crosslinking catalyst to a mixture of a hydroxy-terminated polysiloxane and a crosslinkable polysiloxane having a hydrolyzable functional group, wherein the crosslinking catalyst causes the condensation of the hydroxy-terminated polysiloxane and the generation of water, and wherein the water generated by the condensation hydrolyzes the hydrolyzable functional group resulting in the crosslinking of the crosslinkable polysiloxane. The mixture of the hydroxy-terminated polysiloxane and crosslinkable polysiloxane can be made in a variety of ways.

A representative method for crosslinking polysiloxanes is described in Example 1.

In one embodiment, the method of crosslinking polysiloxanes includes using a first reservoir that includes the hydroxy-terminated polysiloxane and crosslinkable polysiloxane, and a second reservoir that includes the crosslinking catalyst. Such a method is applicable to, for example, inkjet printing methods.

In this embodiment, the method for crosslinking a polysiloxane, comprises

(a) providing a polysiloxane mixture in a first reservoir, wherein the polysiloxane mixture comprises a hydroxy-terminated polysiloxane and a crosslinkable polysiloxane having a hydrolyzable functional group;

(b) providing a crosslinking catalyst composition in a second reservoir;

(c) delivering a portion of the polysiloxane mixture from the first reservoir to a substrate to provide a polysiloxane-treated substrate; and

(d) delivering a portion of the crosslinking catalyst composition from the second reservoir to the polysiloxane-treated substrate to provide a crosslinked polysiloxane.

In one embodiment, the first reservoir is contained within a first chamber of an inkjet printer ink cartridge, and the second reservoir is contained within a second chamber of an inkjet printer ink cartridge.

In another embodiment, the method of crosslinking polysiloxanes includes using a first reservoir that includes the hydroxy-terminated polysiloxane, a second reservoir that includes the crosslinkable polysiloxane, and a third reservoir that includes the crosslinking catalyst.

In further embodiments, additional reservoirs can be used. For example, in one embodiment, the method of cros slinking polysiloxanes includes using a first reservoir that includes the hydroxy-terminated polysiloxane, a second reservoir that includes the crosslinkable polysiloxane, a third reservoir that includes the crosslinking catalyst, and a fourth reservoir that includes a particulate filler in an appropriate liquid dispersing agent. Other embodiments include methods that employ additional reservoirs each including other filler materials and other materials useful in ceramic production.

The above methods are applicable to inkjet printing methods. In these methods, the inkjet printing can provide a shaped preceramic mixture.

The substrate that receives the polysiloxanes (e.g., individual polysiloxanes or polysiloxane mixtures) can be a paper, plastic, wood, metal, or ceramic substrate.

The crosslinking catalyst composition can further include a polysiloxane.

To facilitate inkjet printing, a viscosity lowering agent can be included in either or each of the crosslinking catalyst composition, the polysiloxane polymers, or the polysiloxane mixture. In one embodiment, the crosslinking catalyst composition and the polysiloxane mixture each have a viscosity in the range from about 1 to about 30 mPas. Suitable viscosity lowering agents have viscosities significantly lower than the polysiloxanes and therefore lower the overall composition's viscosity by their addition. Suitable viscosity lowering agents have solubilities and chemical reactivities that are compatible with the system's other components and have relatively low boiling points such that they can be readily removed from the deposited compositions by evaporation. Representative viscosity lowering agents include hydrocarbons, such as hexanes (e.g., n-hexane and i-hexane), heptanes (e.g., n-heptane and i-heptane), octanes (e.g., n-octane and i-octane), and alkoxysilane monomers having the formula: (RO)₄₋ₓRₓSi, where 0≦x≦4, and R is independently selected from methyl and ethyl.

The crosslinking catalyst composition and/or the polysiloxane mixture can further include one or more particulate fillers. Suitable particulate fillers include alumina nanofillers (e.g., Al₂O₃), SiCN, Si₃N₄, ZrO₂, Si, B, and SiC, among others.

In addition to the inkjet printing method for making crosslinked polysiloxanes, other printing processes including continuous inkjet printing (CU) and drop-on-demand (DOD) thermal and piezotechnique processes can be used.

Thus, in a related aspect, the present invention provides an ink system suitable for use with an inkjet printer. The ink system includes (a) a hydroxy-terminated polysiloxane, (b) a crosslinkable polysiloxane having a hydrolyzable functional group; and a crosslinking catalyst. The ink system can further include one or more particulate fillers.

In a further related embodiment, the invention provides an ink that includes a crosslinked polysiloxane obtainable by adding a crosslinking catalyst to a mixture of a hydroxy-terminated polysiloxane and a crosslinkable polysiloxane having a hydrolyzable functional group, wherein the crosslinking catalyst causes the condensation of the hydroxy-terminated polysiloxane and the generation of water, and wherein the water generated by the condensation hydrolyzes the hydrolyzable functional group resulting in the crosslinking of the crosslinkable polysiloxane. The ink can further include one or more particulate fillers.

The use of the polysiloxane system described above in an inkjet printing system is described in Example 2.

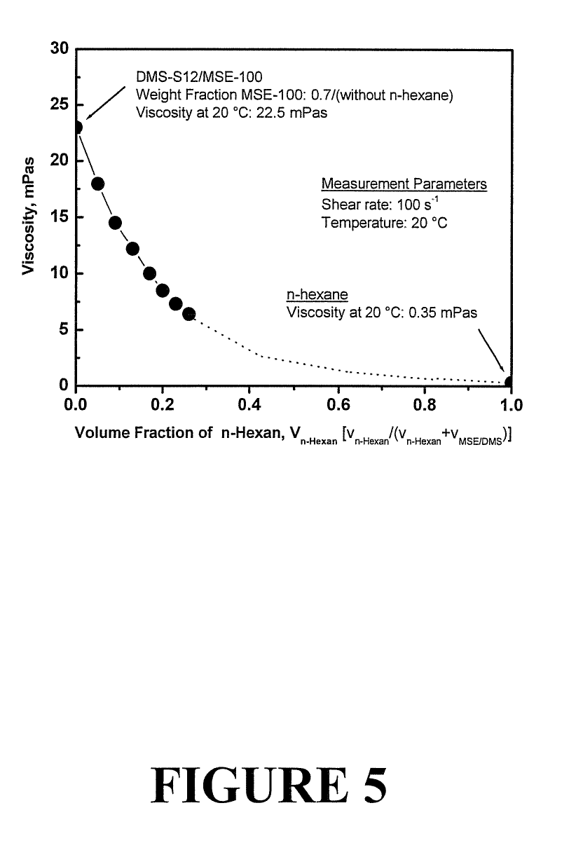

As noted above, to use the polysiloxanes in an inkjet system, viscosity adjustment may be necessary. The viscosity of the starting system with weight fraction of the siliconether M_{MSE-100} =0.7 was found to be 22.5 mPas at 20° C., which is within the upper limit for inkjet printing. When fillers are introduced in the system, the viscosity is expected to increase. To keep the system's viscosity below 30 mPas, which has been shown to be the upper limit for inkjet printing, n-hexane can be used for viscosity adjustment. n-Hexane shows no miscibility gap when mixed with the MSE-100/DMS-S12 system, has a low viscosity of 0.31 mPas at room temperature, and a boiling point of 69° C., which allows for rapid evaporation after printing. These physical properties make n-hexane suitable as a modifier (i.e., viscosity lowering agent) for the preceramic ink system. The viscosity of a DMS-S12/MSE-100/hexane mixture as a function of the n-hexane volume fraction is shown in FIG. 5.

An n-hexane volume fraction of only 0.05 decreased the viscosity to <20 mPas and the sample with a volume fraction of 0.2 showed a viscosity of less than 10 mPas.

It will be appreciated that the crosslinked polysiloxane of the invention can be formed in a variety of ways in addition to the inkjet printing method described above. For example, methods for making the crosslinked polysiloxane include spray methods, paint methods, dip methods, tape casting methods, slip casting methods, and slurry infiltration methods in which the hydroxy-terminated polysiloxane and crosslinkable polysiloxane are treated with the crosslinking catalyst.

The crosslinked polysiloxanes of the invention are useful as preceramic polymers that, along with other fillers and particles, can be pyrolyzed to produce ceramic products.

In another aspect, the invention provides a method for making a ceramic product. The method includes the following steps:

(a) shaping a preceramic polymer mixture to provide a shaped preceramic polymer mixture, wherein the preceramic polymer mixture comprises a mixture of a hydroxy-terminated polysiloxane and a crosslinkable polysiloxane having a hydrolyzable functional group treated with a crosslinking catalyst, wherein the crosslinking catalyst causes the condensation of the hydroxy-terminated polysiloxane and the generation of water, and wherein the water generated by the condensation hydrolyzes the hydrolyzable functional group resulting in the crosslinking of the crosslinkable polysiloxane;

(b) curing the shaped preceramic polymer mixture to provide a cured, shaped preceramic polymer mixture; and

(c) pyrolyzing the cured, shaped preceramic polymer mixture to provide a ceramic product.

The preceramic polymer may be either one or a mixture of the hydroxy-terminated polysiloxane and crosslinkable polysiloxane, or the crosslinked polysiloxane (i.e., the product of treating the hydroxy-terminated polysiloxane and crosslinkable polysiloxane with the crosslinking catalyst).

In one embodiment, shaping is inkjet printing.

In one embodiment, curing the preceramic polymer mixture includes heating at about 110° C. In one embodiment, pyrolyzing the preceramic polymer mixture includes heating at about 1000° C. In another embodiment, pyrolyzing the preceramic polymer mixture includes heating at temperature up to from about 1400° C. to about 1500° C.

Thus, in a related aspect, the invention provides a ceramic product that includes a crosslinked polysiloxane.

The ceramic product is obtainable by the process of:

(a) shaping a preceramic polymer mixture to provide a shaped preceramic polymer mixture, wherein the preceramic polymer mixture comprises a mixture of a hydroxy-terminated polysiloxane and a crosslinkable polysiloxane having a hydrolyzable functional group treated with a crosslinking catalyst, wherein the crosslinking catalyst causes the condensation of the hydroxy-terminated polysiloxane and the generation of water, and wherein the water generated by the condensation hydrolyzes the hydrolyzable functional group resulting in the crosslinking of the crosslinkable polysiloxane;

(b) curing the shaped preceramic polymer mixture to provide a cured, shaped preceramic polymer mixture; and

(c) pyrolyzing the cured, shaped preceramic polymer mixture to provide a ceramic product.

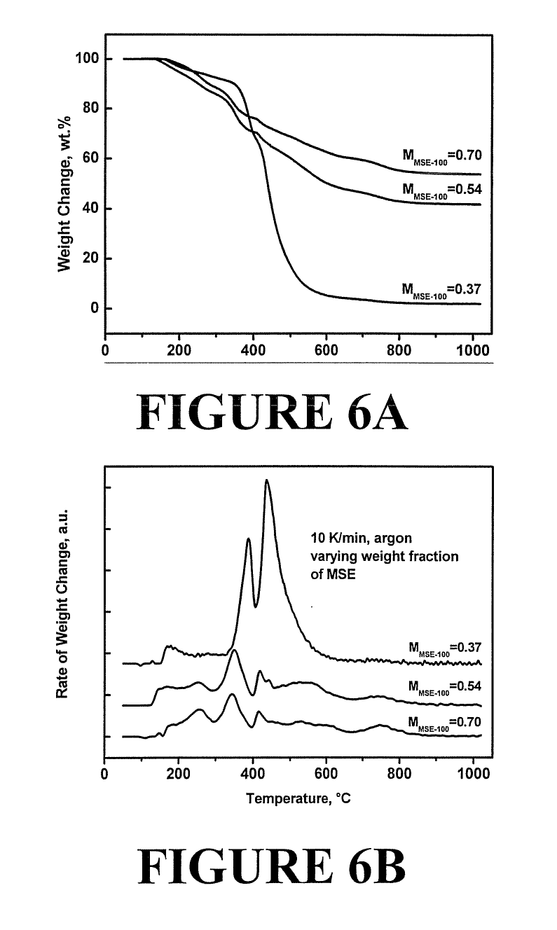

Weight loss and ceramic yield of representative polysiloxane systems of the invention were determined by thermogravimetric (TG) analysis. FIG. 6A illustrates the TG curves for MSE-100/DMS-S12 mixtures with different MSE-100 weight fractions (0.70, 0.54, and 0.37), and FIG. 6B illustrates the first derivative of the TG curves of FIG. 6A. The weight loss increased with increasing amount of MSE-100. The thermal decomposition behavior changed with an increasing MSE weight fraction. The most significant change was observed with the peak in the derivative of the weight loss at 430° C., which decreased significantly with increasing MSE-100 weight fraction, while the peak at 400° C. in this sample shifted to lower temperatures.

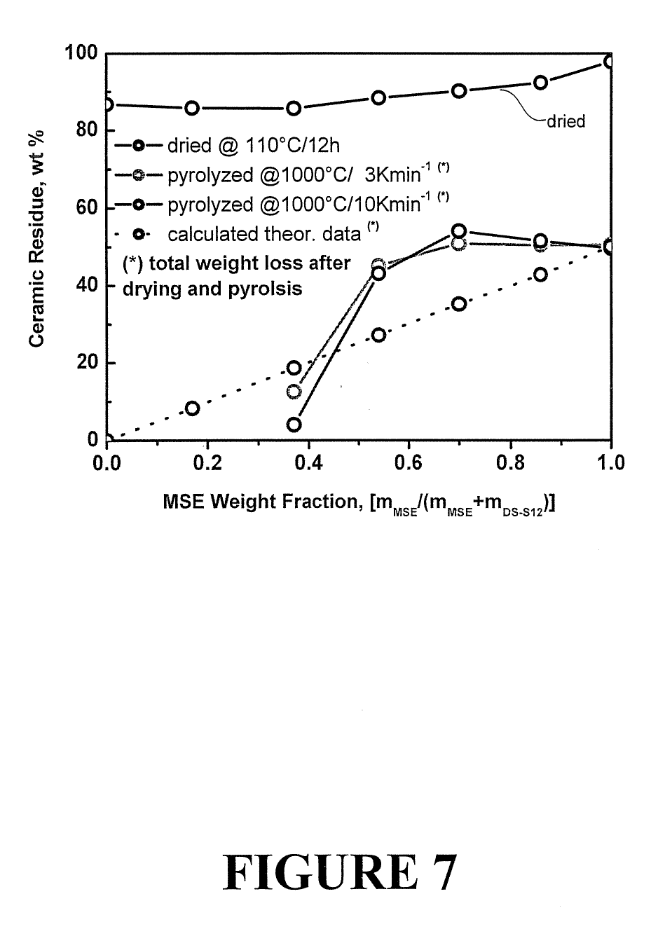

The weight loss after drying at 110° C. and the total weight loss after drying and pyrolysis at 1000° C. in argon atmosphere is shown in FIG. 7. Even at a MSE-100 weight fraction of 0.37 a ceramic yield was detected. With an increasing weight fraction of MSE-100, the ceramic yield increased and showed a maximum at a weight fraction of 0.7 having a value of 54%. A further increase of weight fraction caused a decrease in the ceramic yield. From these findings it can be concluded, that fragments of the polysiloxane may influence the structure of the thermoset, and hence, increase the ceramic yield.

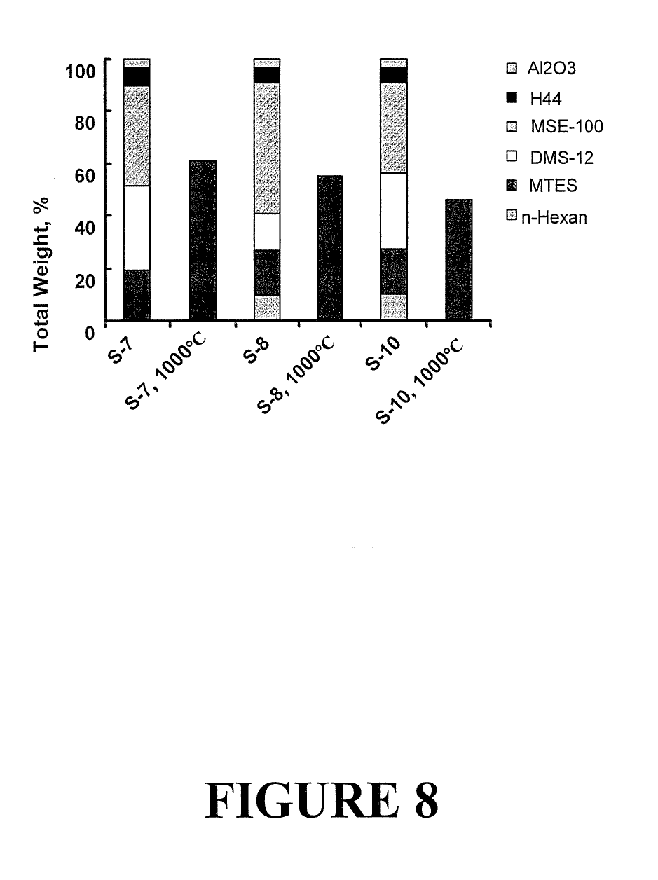

The ceramic yields of three representative polysiloxane systems including additives (S-7, S-8, and S-10) are shown in FIG. 8. The three systems included a representative hydroxyl-terminated polysiloxane (DMS-S12), a representative crosslinkable polysiloxane (MSE-100), a silicone resin (H44), a nanoalumina (Al₂O₃), an alkoxysilane (methyl triethoxy silane, MTES), and a viscosity lowering agent (n-hexane, n-Hexan) (S-7 did not include hexane) in the amounts shown in FIG. 8. Each polysiloxane system showed a substantial ceramic yield after pyrolysis at 1000° C. The results of weight loss clearly indicate the preceramic ink system as a high yield ceramic system after pyrolysis. The ceramic system being derived from a low viscosity liquid prior to cros slinking, curing, and pyrolysis.

In one aspect, the present invention provides a ceramic product from a liquid polymer that is crosslinked by in situ water generation in a room temperature process. The viscosity of the preceramic polymers is sufficiently low so as to permit inkjet printing as a shaping method. The method of the invention differs from traditional ceramic product fabrication, which generally require elevated temperatures and prolonged fabrication times. Traditional methods include, for example, melting a powder and the use of a metal crosslinking catalyst at elevated temperature for prolonged periods of time; the use of a ceramic polymer solution, from which the solvent must be evaporated, or a high viscosity liquid, which also require elevated temperatures and prolonged times for crosslinking. The present invention provides ceramic products from preceramic polymers that are readily shaped and cured rapidly and at low (e.g., room) temperature.

The following examples are provided to illustrate, not limit, the invention.

### Examples

### Example 1

### Representative Method for Polysiloxane Crosslinking

In this example, a representative method for crosslinking silicone compound is described.

A crosslinkable polysiloxane, methoxymethyl(polysiloxane), also known as siliconeether (MSE-100, Wacker Silicone AG, Muenchen, Germany) and a hydroxy-terminated linear dimethylpolysiloxane (DMS-S 12, Gelest Inc. Morrisville, Pa., USA) were used in this study. Both liquid components were mixed with a weight fraction of the MSE-100 M_{MSE}=(m_{MSE}/(m_{MSE}+m_{DMS}) from 0.37 to 1.0. As a crosslinking catalyst operating at room temperature, bis(2-ethylhexanoate)tin, dissolved in 50 wt. % dimethylpolysiloxane (SNB-1101, Gelest Inc. Morrisville, Pa., USA) was added. The amount of catalyst was 1-2 wt. % related to the tin metal.

Viscosity measurements of the samples were carried out with a rotational viscosimeter (Haake V T 550, Thermo Electron GmbH, Karlsruhe, Germany) at 20° C. with shear rates of 10 and 100 s⁻¹ at 20° C. To use the crosslinked polysiloxanes as an ink in an inkjet printer, a viscosity adjustment was made. The viscosity adjustment was carried out with n-hexane, which was added to the MSE-100/DMS-S12 sample that showed the highest ceramic yield after thermal conversion (sample with a MSE weight fraction of 0.7). The n-hexane volume fraction was varied from 0 to 0.26, related to the total volume fraction of the MSE-100/DMS-S12 sample. See FIG. 5.

The as-processed samples were dried at 110° C. for 12 h and subsequently pyrolyzed in argon atmosphere at 1000° C. with a dwell time at maximum temperature of 2 h and a heating rate of 10 K/min, respectively. From the pyrolyzed samples the ceramic yield was calculated. See FIG. 7. The thermal transformation behavior was monitored by thermal analysis (TGA and DTA) with a simultaneously operating thermobalance STA 409A (Netzsch GmbH, Selb, Germany). About 50 mg of sample was placed in an alumina crucible and heated to 1000° C. in argon atmosphere with a heating rate of 10 K/min. See FIGS. 6A and 6B.

### Example 2

### Representative Method for Polysiloxane Crosslinking: Inkjet System

In this example, a representative method for polysiloxane crosslinking using an inkjet printing system is described.

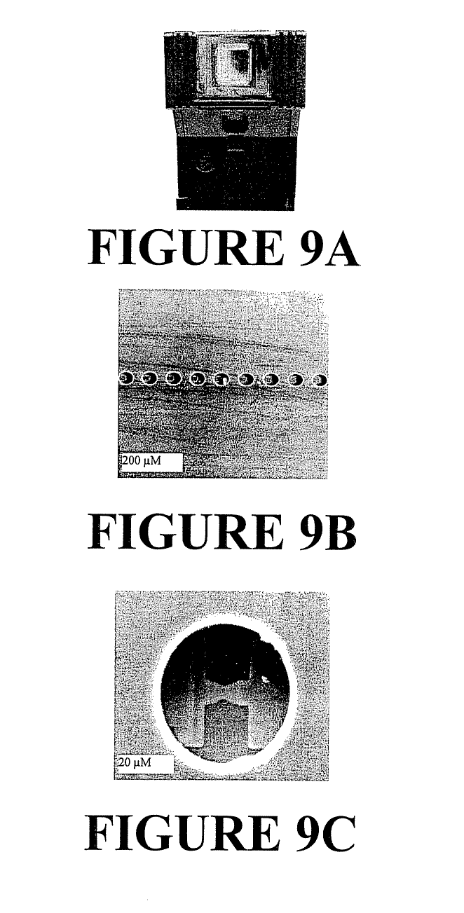

The printing experiments were carried out with a bubble jet printer of the type HP Deskjet 880C. FIGS. 9A-9C are images of the bubble jet printhead design. The color ink cartridge was opened by cutting the upper part with a band saw, removing the sponges from the three ink chambers for the cyan, magenta and yellow cartridge and cleaning the ink chambers with isopropanol by repeated flushing. A mixture of MSE-100/DMS-S12 with a M_{MSE-100}=0.7 was filled in one of the chambers and the catalyst, which was delivered as a solution in polysiloxane, was diluted in n-hexane and poured in another ink chamber. The composition for the first printing experiments was controlled by a CAD and design software iGrafx DESIGNER Version 8.0.0512 (MICROGRAFX Inc., Richardson, Tex., USA). The pull-down menu for the cyan, magenta and yellow color code for the subtractive color mixture allows the composition of each ink to be controlled from 0 to 100 by integer step. The chamber with the MSE-DMS ink was set to 100, and the chamber with the catalyst/n-hexane was set to 3-5. Printing was carried out first on paper and then on aluminum foil that was bonded to a sheet of paper.

While certain embodiments have been illustrated and described, it will be appreciated that various changes can be made therein without departing from the spirit and scope of the invention.

1. A method for crosslinking a polysiloxane, comprising adding a crosslinking catalyst to a mixture of a hydroxy-terminated polysiloxane and a crosslinkable polysiloxane having a hydrolyzable functional group, wherein the crosslinking catalyst causes the condensation of the hydroxy-terminated polysiloxane and the generation of water, and wherein the water generated by the condensation hydrolyzes the hydrolyzable functional group resulting in the crosslinking of the crosslinkable polysiloxane.

2. The method of claim 1, wherein the hydroxy-terminated polysiloxane is a hydroxy-terminated polydimethylsiloxane.

3. The method of claim 1, wherein the crosslinkable polysiloxane is a poly(alkoxyalkyl) siloxane.

4. The method of claim 1, wherein the crosslinkable polysiloxane is a poly(methoxymethyl)siloxane.

5. The method of claim 1, wherein the crosslinking catalyst is bis(2-ethylhexanote)tin.

6. A crosslinked polysiloxane obtainable by the process of adding a crosslinking catalyst to a mixture of a hydroxy-terminated polysiloxane and a crosslinkable polysiloxane having a hydrolyzable functional group, wherein the crosslinking catalyst causes the condensation of the hydroxy-terminated polysiloxane and the generation of water, and wherein the water generated by the condensation hydrolyzes the hydrolyzable functional group resulting in the crosslinking of the crosslinkable polysiloxane.

7. A method for crosslinking a polysiloxane, comprising;
(a) providing a polysiloxane mixture in a first reservoir, wherein the polysiloxane mixture comprises a hydroxy-terminated polysiloxane and a crosslinkable polysiloxane having a hydrolyzable functional group;
(b) providing a crosslinking catalyst composition in a second reservoir;
(c) delivering a portion of the polysiloxane mixture from the first reservoir to a substrate to provide a polysiloxane-treated substrate; and
(d) delivering a portion of the crosslinking catalyst composition from the second reservoir to the polysiloxane-treated substrate to provide a crosslinked polysiloxane.

8. The method of claim 7, wherein the first reservoir is contained within a first chamber of an inkjet printer ink cartridge.

9. The method of claim 7, wherein the second reservoir is contained within a second chamber of an inkjet printer ink cartridge.

10. The method of claim 7, wherein the substrate is paper.

11. The method of claim 7, wherein the crosslinking catalyst composition further comprises a polysiloxane.

12. The method of claim 7, wherein the crosslinking catalyst composition further comprises a viscosity lowering agent.

13. The method of claim 7, wherein the polysiloxane mixture further comprises a viscosity lowering agent.

14. The method of claim 7, wherein the crosslinking catalyst composition further comprises one or more particulate fillers.

15. The method of claim 7, wherein the polysiloxane mixture further comprises one or more particulate fillers.

16. An ink system, comprising:
(a) a hydroxy-terminated polysiloxane;
(b) a crosslinkable polysiloxane having a hydrolyzable functional group; and
(c) a crosslinking catalyst.

17. The ink system of claim 16 further comprising one or more particulate fillers.

18. An ink, comprising a crosslinked polysiloxane obtainable by the process of adding a crosslinking catalyst to a mixture of a hydroxy-terminated polysiloxane and a crosslinkable polysiloxane having a hydrolyzable functional group, wherein the crosslinking catalyst causes the condensation of the hydroxy-terminated polysiloxane and the generation of water, and wherein the water generated by the condensation hydrolyzes the hydrolyzable functional group resulting in the crosslinking of the crosslinkable polysiloxane.

19. The ink of claim 18 further comprising one or more particulate fillers.

20. A method for making a ceramic product, comprising:
(a) shaping a preceramic polymer mixture to provide a shaped preceramic polymer mixture, wherein the preceramic polymer mixture comprises a mixture of a hydroxy-terminated polysiloxane and a crosslinkable polysiloxane having a hydrolyzable functional group treated with a crosslinking catalyst, wherein the crosslinking catalyst causes the condensation of the hydroxy-terminated polysiloxane and the generation of water, and wherein the water generated by the condensation hydrolyzes the hydrolyzable functional group resulting in the crosslinking of the crosslinkable polysiloxane;
(b) curing the shaped preceramic polymer mixture to provide a cured, shaped preceramic polymer mixture; and
(c) pyrolyzing the cured, shaped preceramic polymer mixture to provide a ceramic product.

21. The method of claim 20, wherein curing the preceramic polymer mixture comprises heating at about 110° C.

22. The method of claim 20, wherein pyrolyzing the preceramic polymer mixture comprises heating at about 1000° C.

23. A ceramic product obtainable by the process of:
(a) shaping a preceramic polymer mixture to provide a shaped preceramic polymer mixture, wherein the preceramic polymer mixture comprises a mixture of a hydroxy-terminated polysiloxane and a crosslinkable polysiloxane having a hydrolyzable functional group treated with a crosslinking catalyst, wherein the crosslinking catalyst causes the condensation of the hydroxy-terminated polysiloxane and the generation of water, and wherein the water generated by the condensation hydrolyzes the hydrolyzable functional group resulting in the crosslinking of the crosslinkable polysiloxane;
(b) curing the shaped preceramic polymer mixture to provide a cured, shaped preceramic polymer mixture; and
(c) pyrolyzing the cured, shaped preceramic polymer mixture to provide a ceramic product.
